(19) United States
(12) Patent Application Publication
(10) Pub. No.: US 2026/0181385 A1
(43) Pub. Date: Jun. 25, 2026

(54) SECURE INITIALIZATION OF TRANSMISSION SECURITY (TRANSEC) ENABLED TERMINALS IN A SATELLITE COMMUNICATION NETWORK

(71) Applicant: Hughes Network Systems, LLC, Germantown, MD (US)

(72) Inventors: Satyajit Roy, Gaithersburg, MD (US); Krishna Samavedam, Rockville, MD (US)

(21) Appl. No.: 18/987,263

(22) Filed: Dec. 19, 2024

(51) Int. Cl. H04W 12/037; H04W 60/04; H04W 72/0453; H04W 84/06

(52) U.S. Cl. CPC H04W 12/037; H04W 60/04; H04W 72/0453; H04W 84/06

(57) ABSTRACT

Approaches are described herein for securely initializing a TRANSEC-enabled terminal (TET) in a satellite communication network. At a secure location, a unique Terminal Master Key and Electronic Serial Number, are securely burned into the terminal's memory. Upon booting, the terminal verifies its identity using a signed TE file and encrypted keys. When deployed, the terminal initially sends an unallocated burst with a fake ESN to obtain bandwidth allocation (e.g., from an inroute bandwidth allocator). The terminal proceeds with an initial association request using a randomly generated identifier, followed by a transport-layer-secure registration process (e.g., with a network management system over HTTPS). After successful registration, the TET receives link-layer key materials and shifts to using its real ESN with link-layer security (LLS) for subsequent communications.

### BACKGROUND OF THE INVENTION

In satellite communication networks, satellites communicate with ground stations. At least because the satellites have predictable orbits, constant emission of signals, and transmissions with wide geographic footprints, their communications present significant challenges in terms of communication security. Transmission Security (TRANSEC), in context of satellite communication systems, generally describes technologies that seek to safeguard the integrity and confidentiality of signals transmitted between satellites and ground stations, such as by preventing adversaries from intercepting, jamming, or exploiting satellite signals for intelligence purposes, even when the content is encrypted.

Some TRANSEC technologies, such as frequency hopping, spread spectrum modulation, and signal encryption, are designed to obscure physical characteristics of the transmission. Other TRANSEC technologies control electromagnetic emissions and the timing of signal transmissions. For example, an adversary could potentially track satellite positions and infer communication patterns, even if they cannot access the actual content of the communication, but TRANSEC protocols can minimize the detectable electromagnetic signature through power control and low-probability-of-intercept (LPI) techniques to reduce the chance of detection by enemy surveillance systems. Additionally, satellite communications often employ encryption at the transmission level to protect metadata, such as the time and duration of communications, which can provide critical information about operational patterns. These and/or other TRANSEC technologies can appreciably enhance the security and resilience of their communication networks in contested environments.

### BRIEF SUMMARY OF THE INVENTION

Systems and methods are described herein for securely initializing a TRANSEC-enabled terminal (TET) in a satellite communication network. At a secure location, a unique Terminal Master Key and Electronic Serial Number (ESN), are securely burned into the terminal's memory. Upon booting, the terminal verifies its identity using a signed TE file and encrypted keys. When deployed, the terminal initially sends an unallocated burst with a fake ESN to obtain TDMA inroute bandwidth allocation (e.g., from an inroute bandwidth allocator). The terminal proceeds with an initial association request using a randomly generated identifier, followed by a transport-layer-secure registration process (e.g., with a network management system over HTTPS). After successful registration, the TET receives link-layer key materials and shifts to using its real ESN with link-layer security (LLS) for subsequent communications.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows an example of a hybrid satellite communication system (i.e., having both TRANSEC-enabled and non-TRANSEC-enabled terminals), as a context for embodiments described herein.

FIG. 2 shows another example of a hybrid satellite communication system, including block diagrams of an illustrative TRANSEC-enabled terminal, an illustrative non-TRANSEC-enabled terminal, and an illustrative unified ground station.

FIG. 3 shows a ladder diagram for an illustrative secure terminal registration procedure, according to embodiments described herein.

FIG. 4 shows a flow diagram of an illustrative method for initial configuration of a TRANSEC-enabled terminal, according to embodiments described herein.

FIG. 5 shows a flow diagram of an illustrative method for initializing a TRANSEC-enabled terminal for secure communications in a satellite communication network, according to embodiments described herein.

FIGS. 6A and 6B provide schematic illustrations of embodiments of computational systems that can implement various system components and/or perform various steps of methods provided by various embodiments.

### DETAILED DESCRIPTION OF THE INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

TRANSEC (Transmission Security) prevents an adversary from exploiting information available in a communication channel without necessarily having defeated encryption. TRANSEC can require all network control channels and Management & Control (M&C) data to be encrypted and that any and all traffic engineering information be obfuscated from an adversary. For example, TRANSEC requires a communication channel to appear completely full to an adversary, even if little or no actual data is flowing. This is contrasted with communications security (COMSEC), where actual information is encrypted, but certain header information is sent in the clear. From these, an adversary can determine how much of the traffic streams is voice, video, or data.

TRANSEC is not a new area of technology. For example, some TRANSEC concepts are outlined by the National Security Agency (NSA). However, embodiments described herein provide novel TRANSEC technologies in context of satellite communication networks, including technologies for addressing several deficiencies of conventional TRANSEC concepts.

One such deficiency relates to securely registering TRANSEC-enabled terminals. This can include securely implementing installation, commissioning, and/or other registration-related features. For example, conventional approaches are unable to provide secure communications with terminals prior to completion of a terminal's registration. Embodiments described herein include techniques for securing communications with TRANSEC-enabled terminals even prior to registration.

Another such deficiency relates to control and management channel security. Embodiments provide smart protocols designed to support control and management plane security by encryption, masking, and/or obfuscation. Some embodiments provide techniques to address other deficiencies, which relate to secure terminal installation and registration support.

Another such deficiency relates to masking channel activity. In a Single Channel Per Carrier (SCPC) satellite communication network, each communication channel is assigned a specific frequency and bandwidth. In such networks, the link is static with no variation in transmission characteristics based on end user communication. An adversary looking at a satellite transponder with a spectrum analyzer can see a constant radiofrequency (RF) signal. For example, this can be contrasted with time division multiple access (TDMA) and frequency division multiple access (FDMA) networks. Embodiments include approaches to tackle masking channel activity in such network environments, which can be technologically complex.

Another such deficiency relates to obfuscating acquisition activity. In TDMA networks, dedicated unallocated bursts are configured for acquisition of inroute by requesting stream bursts, timing, and power adjustments. The rate at which remotes acquire into a network can provide critical information to an adversary about troop activities. TDMA networks provide a dedicated channel for remote acquisition activity. If adversaries monitor the activity in this channel, they can be alerted to troop movements by a flurry of acquisition activity. Embodiments include approaches to address these concerns.

Embodiments described herein provide effective TRANSEC in satellite communication networks that have a hybrid of TRANSEC-enabled (TE) and non-TRANSEC-enabled (NTE) terminals, without adding system overhead in terms of satellite bandwidth usage. Embodiments described herein can operate in a variety of satellite communication network contexts. For example, embodiments can be implemented in context of both geosynchronous orbit (GEO) and non-geosynchronous orbit (NGSO) satellites, such as low Earth orbit (LEO) and medium Earth orbit (MEO) satellites. Embodiments can also be implemented with satellites having different capacities, such as high throughput satellites (HTS), very high throughput satellites (VHTS), etc. Embodiments can also be implemented with different satellite capabilities, such as regenerative satellites of a LEO constellation having flexible channelizers.

### Hybrid TRANSEC/Non-TRANSEC Satellite Communication Systems

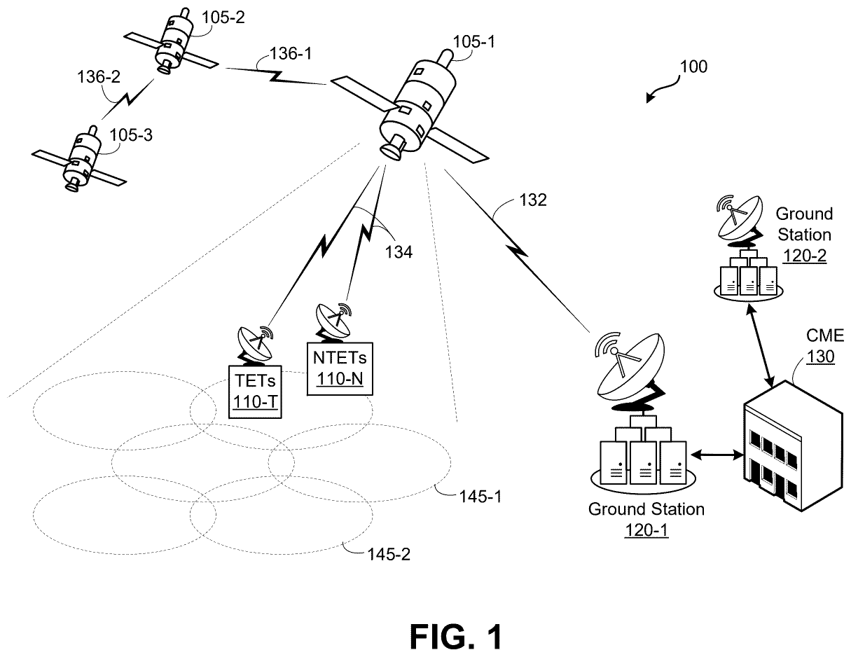

FIG. 1 shows an example of a hybrid satellite communication system 100 (i.e., having both TRANSEC-enabled and non-TRANSEC-enabled terminals), as a context for embodiments described herein. As illustrated, the satellite communication system 100 includes one or more ground stations 120 in communication with a large number of geographically diverse user terminals (UTs) 110 via one or more satellites 105. The illustrated communication system 100 includes a constellation of satellites 105. The UTs 110 are located in cells 145. The ground stations 120 can be in communication with a central management entity (CME) 130 via a terrestrial infrastructure.

The satellites 105 can include any suitable type of communication satellite. In some implementations, some or all of the satellites 105 are geostationary Earth orbit (GEO) satellites. Such GEO satellites are generally positioned in a geosynchronous orbit approximately 35,786 kilometers above the equator, so as to remain fixed relative to a point on the surface of the Earth. In other implementations, some or all of the satellites 105 are non-geosynchronous orbit (NGSO) satellites, such as medium Earth orbit (MEO) satellites that typically orbit the Earth at altitudes between around 2,000 and 35,786 kilometers, and/or low Earth orbit (LEO) satellites that typically orbit the Earth at altitudes ranging from about 160 to 2,000 kilometers. In some implementations, some or all of the satellites 105 can have large chassis. For example, a satellite 105 can have a chassis approximately the size of a bus. In other implementations, some or all of the satellites 105 can have small chassis. For example, so-called “smallsats” can include femtosatellites typically weighing less than 100 grams, picosatellites typically weighing between 100 grams and 1 kilogram, nanosatellites typically weighing between 1 and 10 kilograms, microsatellites typically weighing between 10 and 100 kilograms, and minisatellites typically weighing between 100 and 500 kilograms. As one common example, so-called “CubeSats” are a type of nanosatellite with a standard CubeSat unit (1 U) defined as a 10 cm cube with a mass up to 1.33 kilograms.

The communication system 100 includes a large number of user terminals 110. One or more (or all) of the user terminals 110 can be implemented as Very Small Aperture Terminals (VSATs). VSATs are small satellite dishes that can be used for a variety of applications, including internet access, data communication, and voice over IP (VoIP) services. VSATs can be mobile or fixed terminals. Additionally or alternatively, the user terminals 110 can be implemented as or in desktop computers, laptops, smartphones, tablets, industrial control devices, Internet of Things (IoT) devices, specialized communication equipment, etc.

As illustrated, the satellites 105 communicate with user terminals 110 via one or more user links 134 and with ground-based infrastructures (e.g., ground stations 120) via one or more feeder links 132. Forward-link communications can be sent from a ground station 120 up to a satellite 105 via an uplink portion of a feeder link 132 (i.e., a “feeder uplink,” a “forward uplink,” etc.) and from the satellite 105 down to one or more user terminal 110 via a downlink portion of one or more user links 134 (i.e., a “user downlink,” a “forward downlink,” etc.). Return-link communications can be sent from a user terminal 110 up to a satellite 105 via an uplink portion of a user link 134 (i.e., a “user uplink,” a “return uplink,” etc.) and from the satellite 105 down to a ground station 120 via a downlink portion of a feeder link 134 (i.e., a “feeder downlink,” a “return downlink,” etc.).

In implementations having a constellation of satellites 105, the satellite constellation can include several (e.g., tens of) satellites 105, hundreds or even thousands of satellites 105, etc. Some or all of the satellites 105 can communicate with adjacent satellites in their constellation via inter-satellite links (ISLs) 136. ISLs 136 allow direct communication between satellites without relaying data back to the Earth, which can enhance the reliability, robustness, and speed of communications. In some implementations, the ISLs 136 facilitate communication between adjacent satellites 105 sharing a same orbital plane. In other implementations, the ISLs 136 facilitate communication between satellites 105 in adjacent orbital planes.

As illustrated, the communication system 100 can include a centralized management entity (CME) 130. The CME 130 can be implemented as one or more entities in one or more locations to provide features associated with orchestration and optimization of network operations, including scheduling, resource allocation, traffic management, and overall network coordination. In some implementations, the CME 130 is located at one or more central ground stations. In other implementations, the CME 130 is located at an operations center, such as a network operations center (NOC), a satellite operations center (SOC), global network operations center (GNOC), etc. In such locations, the CME 130 has access to robust computational resources and high-bandwidth terrestrial connectivity by which to effectively monitor and control the entire satellite network infrastructure. The CME 130 can communicate with ground stations 120 through high-speed terrestrial links and/or dedicated satellite communication channels.

As illustrated, some of the user terminals 110 are TRANSEC-enabled (TE) terminals (TET) 110-T, and others of the user terminals 110 are non-TRANSEC-enabled terminals (NTET) 110-N. As used herein, each TET 110-T is designed to ensure the security and integrity of data transmitted over satellite links. The TETs 110-T are equipped with specialized modules that implement TRANSEC measures, which can include encryption, frequency hopping, and other advanced techniques to protect data from interception, jamming, and unauthorized access. Conversely, as used herein, each NTET 110-N is a user terminal 110 that does not incorporate TRANSEC measures. These terminals are designed to handle standard satellite communication tasks without the added layer of transmission security provided by encryption and other TRANSEC techniques. Some embodiments described herein facilitate use of novel TET 110-T communications along with conventional NTET 110-N communications in a same network, so that novel techniques described herein are compatible augmentations to existing NTET 110-N infrastructures.

The communication system 100 includes one or more ground stations 120. As used herein, a ground station 120 generally refers to a primary interface between terrestrial networks and satellites at the feeder side of the network. Ground stations 120 typically include at least an antenna system for transmitting and receiving signals to and from the satellite and a modem/router to process the signals. The processing can include modulation and demodulation, error correction, encryption/decryption, protocol management, etc. In some cases, the ground stations 120 can include higher level functions, such as a network management system (NMS) to continuously monitor and manage network performance (e.g., fault detection, performance analysis, configuration management, etc.) and/or a control center to coordinate with the NMS to ensure optimal network functionality and to manage data traffic flow. In some implementations, NMS, control center, and/or other functions are handled by the CME 130, or in conjunction with the CME 130.

As described herein, TRANSEC communications involve security both at the user terminal 110 (TET 110-T) side and at the ground station 120 side of the network. Although not explicitly shown, some embodiments of the communication system 100 include separate TE ground stations 120 and non-TE ground stations 120. In such embodiments, TETs 110-T are in communication with TE ground stations 120, and NTETs 110-N are in communication with non-TE ground stations 120. For example, all data passing through a TE ground station 120 is secure and adheres to TRANSEC protocols. Such embodiments can provide certain features, such as providing clear separation of secure and non-secure communications to simplify security management and reduce the risk of accidental data breaches, and/or simplifying processing of non-TE communications without additional overhead concerns. However, such embodiments can also be more complex (e.g., maintaining and managing separate ground stations can increase the complexity of the network infrastructure), more expensive (e.g., additional hardware and management resources may be involved in supporting separate ground stations), etc. Further, such embodiments can reduce network efficiencies, such as relating to data routing, load balancing, failure handling, etc., by restricting user terminals 110 to communicate only with portions of otherwise available ground stations 120 (e.g., TETs 110-T can only use resources of TE ground stations 120).

Other embodiments use unified ground stations 120 that support both TE and non-TE communications. In such embodiments, all ground stations 120 have integrated TRANSEC capabilities but can handle non-TRANSEC data, as well. For example, such unified ground stations 120 can apply encryption/decryption as needed for TE data while allowing non-TE data to pass through without encryption. Such embodiments can result in each ground station 120 being more complex. However, such embodiments can simplify network design and management and can increase flexibility and adaptability by allowing all ground stations 120 to dynamically handle both secure and non-secure communications.

Embodiments are generally described herein assuming an architecture in which at least some of the ground stations 120 are unified ground stations. For example, all ground stations 120 may be unified ground stations 120, some ground stations 120 are unified ground stations 120 and the rest are non-TE ground stations 120, or some ground stations 120 are unified ground stations 120 and the rest are a combination of TE and non-TE ground stations 120. References herein to ground stations 120 generally assume a unified ground station 120, unless noted otherwise.

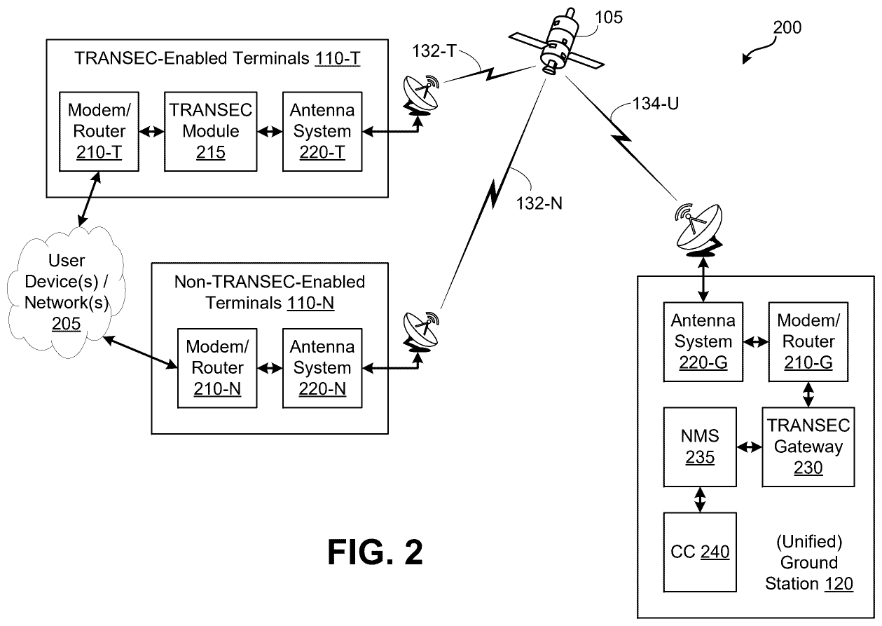

FIG. 2 shows another example of a hybrid satellite communication system 200, including block diagrams of an illustrative TET 110-T, an illustrative NTET 110-N, and an illustrative unified ground station 120. The satellite communication system 200 is designed to facilitate secure and non-secure communication across various user terminals 110 through one or more satellites 105 (only one is shown). The system includes TRANSEC-enabled terminals (TETs 110-T) and non-TRANSEC-enabled terminals (NTETs 110-N), each having distinct components tailored to their security needs.

Each TET 110-T includes at least a modem/router 210-T, a TRANSEC module 215, and an antenna system 220-T. The modem/router 210-T handles standard communication protocols, data formatting, and network management tasks. The TRANSEC module 215 is positioned between the modem/router 210-T and the antenna system 220-T, ensuring that outgoing data is encrypted and incoming data is decrypted, providing end-to-end security. The antenna system 220-T is responsible for sending and receiving encrypted signals to and from the satellite 105.

Each NTET 110-N includes at least a modem/router 210-N and an antenna system 220-N (i.e., the NTETs 110-N do not include TRANSEC modules 215). The modem/router 210-N manages data formatting, protocol conversion, and network routing without the additional security layer provided by a TRANSEC module. The antenna system 220-N transmits and receives unencrypted signals to and from the satellite.

Both TETs 110-T and NTETs 110-N connect to user device(s) and/or network(s) 205. For example, on the hardware side, the user device(s)/network(s) 205 can include computers, workstations, mobile devices, peripheral devices, networking equipment, file servers, application servers, database servers, storage devices, cloud storage solutions, sensors, Internet-of-things (IoT) devices, VoIP phones, antennas, satellite dishes, modems, transceivers, firewalls, security appliances, power supply units, etc. On the software side, user device(s)/network(s) 205 can include operating systems, communication software, network management software tools, security software, data management software, productivity software, virtualization software, collaboration tools, etc. On the network side, user device(s)/network(s) 205 can include any suitable user networks, such as local area networks (LANs), wide area networks (WANs), metropolitan area networks (MANs), virtual private networks (VPNs), enterprise networks, industrial control networks, IoT networks, mobile networks, hybrid networks, cloud networks, etc. User device(s)/network(s) 205 can also include connectivity and/or integration components (e.g., APIs and middleware), virtual private networks and/or remote access solutions, cloud services, user interface components and/or user portals, etc. In some implementations, user device(s)/network(s) 205 can include support and/or maintenance components, remote management tools, etc.

The ground station 120 (illustrated as a universal ground station 120) includes a modem/router 210-G, an antenna system 220-G, a TRANSEC gateway 230, a network management system (NMS) 235, and a control center (CC) 240. The modem/router 210-G interfaces with both TETs 110-T and NTETs 110-N, handling data formatting and routing for secure and non-secure communications. The antenna system 220-G transmits and receives signals to and from the satellite 105. The TRANSEC gateway 230 is responsible for encrypting and decrypting data (i.e., to ensure secure communications with TETs 110-T).

As noted above, some implementations of ground stations 120 can include an NMS 235 and/or a CC 240. The NMS 235 monitors and manages the satellite network, providing real-time performance analysis, fault detection, and configuration management. The Control Center 240 oversees the overall network operations, coordinating with the NMS 235 to manage data traffic flow and ensure efficient operation of the satellite communication system 200. The ground station 120 can include additional components, such as for interfacing with a terrestrial backhaul network, for interfacing with a CME 130, etc.

In the return direction, TETs 110-T communicate management plane data with the satellite 105 via TE user links 132-T (i.e., secure). The NTETs 110-N communicate with the satellite 105 via a via non-TE user links 132-N (insecure). Those signals are received by the ground station 120 from the satellite 105 via feeder links 134-U (carrying secure and insecure communications). Upon reaching the ground station 120, the signals are first received by the antenna system 220-G, which is responsible for capturing and directing the signals to the appropriate processing units. The received signals are then passed to the modem/router 210-G, which handles the initial signal processing, such as demodulation and protocol conversion. For secure communications, the data is then routed to the TRANSEC gateway 230, where encrypted data from TETs 110-T is decrypted. The decrypted data, along with the unencrypted data from NTETs 110-N, is forwarded to the NMS 235, which monitors and manages the data, ensuring optimal network performance and addressing any faults or issues. The NMS 235 can forward the processed data to the CC 240, which oversees the overall network operations and coordinates the flow of data to other portions of the ground network.

In the forward direction, the management plane data originates from the ground network (e.g., from content sources, the Internet, backhaul networks, other ground terminals 120, the CME 130, etc.) and is sent to the CC 240 at the ground station 120. The CC 240 can manage and organize the data and can pass the data to the NMS 235. For secure communications, the data is routed to the TRANSEC gateway 230, where it is encrypted. Both encrypted data for TETs 110-T and unencrypted data for NTETs 110-N are then processed by the modem/router 210-G, which formats the data for satellite transmission. The formatted signals are transmitted to the antenna system 220-G, which then sends the signals to the satellite 105 via feeder links 134-U. The satellite 105 relays the secure data to TETs 110-T via TE user links 132-T and the insecure data to NTETs 110-N via non-TE user links 132-N.

### Secure Registration of TRANSEC-Enabled Terminals

In general, a TRANSEC-enabled network can have only TETs 110-T or a mix of TETs 110-T and NTETs 110-N. Some embodiments described herein support a hybrid network of both TETs 110-T and NTETs 110-N without increasing system overhead in terms of satellite bandwidth usage.

Typically, a TET 110-T is created specially at a secure factory location. A group of secret information is included in the terminal factory image to designate whether the user terminal 110 terminal a is TET 110-T or not (an NTET 110-N). Only the terminal software can read and interpret this secret information. Each TET 110-T is uniquely associated with a Terminal Master Key (TMK) and an Electronic Serial Number (ESN) of its internal circuitry (e.g., its application-specific integrated circuit, ASIC). A trusted agent (TA) burns the TMK and the ESN in a secure memory location which only software of the specific TET 110-T can retrieve.

An Effective Master Key (EMK) is generated for a specific TET 110-T, and the EMK is loaded into the NMSs 235 of ground stations 120. This is used for a terminal authentication procedure and for generation of encrypted traffic link-layer session keys. The link-layer session keys are derived from a Root Session Key (RSK) and are encrypted by the EMK before being distributed securely to TETs 110-T. Concurrently, the EMK is also encrypted by the TMK to generate an Encrypted Effective Master Key (EEMK), which is then distributed over the air to the TET 110-T. The link-layer session keys are used to encrypt over-the-air unicast user and control traffic. A TET 110-T first decrypts the EEMK using the TMK to get its EMK, which it can then use to decrypt the link-layer session keys. The decrypted link-layer sessions keys can then be used to encrypt and decrypt traffic over the air.

Embodiments described herein include novel techniques for securely registering TETs 110-T in a network. Embodiments begin by calling an application programming interface (API) into the user terminal 110 in a secure physical location and by a trusted agent (TA). In some implementations, the API is part of the same API used to burn the TMK, ESN, and media access control (MAC) address. In other implementations, the API is a dedicated API. The API includes an argument to indicate whether a user terminal 110 is a TET 110-T. In some embodiments, after creating a TET 110-T, the TA deletes the copy of the TMK, thereby preventing converting a returned NTET 110-N terminal to a TET 110-T at the factory for security reasons.

If the user terminal 110 is a TET 110-T, a signed TE file is created. This is not visible as a file in the flash file system; rather it is burned into the factory image and is secret to others. In some implementations, the signed TE file is burned into the factory image as part of establishing the user terminal's 110 in-system programmable device identifier (ISPDID). The user terminal 110 includes embedded systems and/or programmable hardware, such as one or more application-specific integrated circuits (ASICs) and/or field-programmable gate arrays (FPGAs). In this context, the ISPDID is a specific configuration image programmed into an ASIC, FPGA, or the like, which provides a baseline configuration pre-installed on the user terminal 110 at the factory. The image typically includes essential firmware, software drivers, initial settings, and security features. In implementations herein, the ISPDID can include the signed TE file.

A well-known string is signed by generating a 256-bit key called the signature master key (SMK). The SMK is encrypted by the TMK to produce the encrypted signature master key (ESMK). A well-known clear string (KS) is encrypted by the SMK, resulting in the encrypted well-known string (EKS). In some embodiments, effective master keys (EMKs) are created by the TA using a predetermined algorithm and method. The same algorithm and method that are used by the TA to create EMKs can be used to create SMKs. However, the TA does not create the SMKs; rather the SMKs are created in the factory. The secret information in the factory image contains the ESMK and the EKS, not in clear.

On every boot, a user terminal 110 inspects its internal information to determine whether the signed TE file is present. If a user terminal 110 does not find the signed TE file at all, it acts as a NTET 110-N. If the signed TE file is present, the user terminal 110 performs a reverse process. It first decrypts the ESMK using the TMK to get the SMK. Then, it decrypts the EKS by the SMK to get the KS. If the decryption successfully produces the KS (which is a well-known string, by definition), the user terminal 110 internally identifies itself as a TET 110-T. If the signed TE file is present in the user terminal 110, but the KS could not be recovered, the user terminal 110 shuts down its transmit/receive (Tx/Rx) path and does not process any system information after the demodulation lock. The user terminal 110 also displays an appropriate state code in the local user interface (LUI), which indicates this user terminal 110 should not operate anymore.

Notably, if someone copies the signed TE file to another user terminal 110, the check will fail. Thus, the KS will not be successfully recovered, and the state code will be displayed in the LUI. This is because the SMK, stored as the ESMK, can only be decrypted by the TMK, which is highly secure. The correct SMK cannot be obtained by another user terminal 110 that has a different TMK.

Once a TET 110-T is deployed in the field, this approach prevents anyone from degrading the TET 110-T to a NTET 110-N. As noted above, the signed TE file is included in the factory image (e.g., in the ISPDID) to designate whether a terminal is TE or not. Only the TET 110-T itself can read and interpret this secret information.

An aspect of secure registration of TETs 110-T is to prevent adversaries from accessing secure information about TETs 110-T and/or about the network. For example, a user terminal 110 to be used as a TET 110-T is loaded with digital certificates at the factory to support a TET's 110-T commissioning and registration procedure over HTTPS. However, as illustrated below, merely adopting digital certificates-based authentication and/or transport layer security (TLS) handshaking for secure HTTP does not tend to provide end-to-end registration security.

According to embodiments described herein, a TET 110-T obtains its link-layer key materials (including traffic session keys) after the completion of authentication and registration of the TET 110-T with the NMS 235. The session keys are used to protect outroute generic stream encapsulation (GSE) protocol data units (PDUs) and inroute time division multiple access (TDMA) bursts data. However, before this, operation of the TET 110-T still involves exchanging messages with the NMS 235, including sending and receiving management messages. These messages include some terminal-specific identities and information, and embodiments herein ensure that those terminal-specific identities are encrypted end-to-end.

On inroute, the TET 110-T first sends an unallocated burst communication to obtain stream bandwidth, so that it can send registration messages to the NMS 235. In one implementation, the burst communication is sent using the ALOHA (Additive Links On-line Hawaii Area) protocol. In a normal case, the TET 110-T includes context information in the unallocated burst to an inroute bandwidth allocator (IBA) which contains the ESN of the TET 110-T as the terminal identity. The IBA uses this information to create the terminal context for the purpose of allocating bandwidth and for correlating the reception of inroute bursts with the correct terminal.

Notably, if the terminal identity (ESN) is sent in the clear, adversaries can eavesdrop on the ESN and can later compromise the TET 110-T. Unfortunately, user terminals 110 only obtain their link-layer key materials after the completion of registration. As such, the user terminals 110 cannot encrypt the ESN in the unallocated burst that is sent to receive bandwidth allocation as part of the registration process (i.e., as part of sending registration-related messages to the NMS 235).

Embodiments herein perform registration initially with a fake ESN (f-ESN). Instead of using the real ESN as the user terminal's 110 context information during registration, the f-ESN is used as a temporary context until the user terminal 110 obtains its link-layer keys.

The TET 110-T selects an inroute set that supports TETs 110-T. The indication that an inroute set can be used by TETs 110-T can be provided by the IBA via a flag in the inroute set definition message. In this context, an inroute set is a predefined group of frequency channels and time slots used for transmitting data from user terminals 110 back to the satellite 105 and ultimately to the ground station 120. This configuration allows for efficient and organized management of the return link, ensuring that data from multiple user terminals can be transmitted without interference. The IBA is a mechanism to allocate specific frequency channels and time slots within the inroute set to individual user terminals 110. The IBA is responsible for managing the available bandwidth and ensuring that each user terminal 110 is assigned the appropriate resources based on its communication needs and network conditions. The IBA can be managed by the NMS 235, or otherwise in the ground station 120.

To determine that an inroute set supports TRANSEC (Transmission Security), the IBA can evaluate several criteria. For example, it can check the configuration settings of the inroute set to ensure that TRANSEC encryption and decryption protocols are enabled, verifying that the necessary cryptographic algorithms and keys are in place. The IBA can then assess the capabilities of the user terminals 110 within the inroute set to confirm that TETs 110-T have the required hardware and software components (e.g., a TRANSEC module 215) to support secure communication. The IBA can also monitor data traffic within the inroute set to verify that all transmitted data is encrypted according to TRANSEC standards, checking that data packets are properly encrypted before transmission and decrypted upon reception. Additionally, the IBA can ensure that key management processes are functioning correctly, including the generation, distribution, and rotation of encryption keys. The IBA can then verify that the inroute set complies with the network's security policies and protocols, adhering to guidelines for secure data transmission, access control, and intrusion detection.

As noted above, instead of using a real ESN for terminal context, the TET 110-T provides the f-ESN. The f-ESN is sent according to a predefined packet format that allows the IBA to recognize the ESN as fake. In particular, a designated portion of the packet format (e.g., a designated bit) of the burst transmission indicates to the IBA whether the ESN is real or fake, thereby triggering the IBA to allocate stream bandwidth in an appropriate manner. In one implementation, consistent with using the ALOHA protocol for the burst transmission, a 32-bit packet format is defined as follows: The most significant bit is set to 1 to indicate to the IBA that this is a fake ESN so that the IBA accepts it and allocates stream bandwidth and can operate differently as required; the next 3-bits are reserved (e.g., always set to zero); the next 8-bits represents the inroute group identifier of the group from where the user terminal 110 selects its ALOHA aperture; the next 12-bits are used to convey the frame number (the least twelve significant bits of a full frame number), the frame which the terminal has selected for the ALOHA burst; and the next 8-bit represent which chronological ALOHA aperture within the inroute group the terminal is selected for transmission (e.g., assuming a maximum of 256 ALOHA apertures supported in one inroute group).

When “diversity ALOHA” is configured, the same f-ESN can be used with the ALOHA burst sent on a different frame. The number matching the earlier of the two diverse bursts can be used in both bursts. For example, sending the f-ESN in the above manner avoids collisions between user terminals 110 when multiple TETs 110-T are getting commissioned at the same time, or nearly at the same time, or overlapping each other in time. If two or more user terminals 110 select the same frame and the same ALOHA number within an inroute group, the ESN can be the same. However, in such a case, ALOHA collision will happen anyway, and all user terminals 110 will execute a random backoff for their retrying events (according to the aloha protocol).

In some embodiments, the inroute group identifier space is unique system wide. In other embodiments, the inroute group identifier space is unique only within a user beam, not system wide. Therefore, an IBA supporting multiple beams and inroute sets can have inroute groups from multiple beams, and therefore, inroute group identifiers may not be unique in the f-ESN. Although this will tend to be a rare event, the f-ESN from multiple user terminals 110 can collide during the overlapping commissioning time. In such an event, the IBA would think colliding messages are coming from the same user terminal 110 and would tend only to use the information it processes last. As such, the bandwidth would be allocated to one of the user terminals 110 and not to the other. Further, the other user terminal 110, being in a different beam, will not see the allocations. Embodiments treat this in the same manner as a typical ALOHA collision. User terminals 110 not getting the allocation will go back to an inactive state and will try subsequent ALOHAs. Due to random backoff in selecting an ALOHA channel, there is a negligible chance of a repeated ESN collision. Notably, using the above approach, it is not possible to have collision between a f-ESN and a real ESN.

One potential concern is that, if a TET 110-T is compromised, one could use many f-ESN requests to simulate a case of denial-of-service attacks on the IBA. To address this concern, the IBA can validate the f-ESN based on its structure by checking if the inroute group ID, frame number, and ALOHA number in the f-ESN are valid and legitimate (according to a known ALOHA configuration). Otherwise, the IBA can reject the burst.

Another potential concern is that one can send f-ESNs from a compromised TET 110-T that may collide with real ESNs. To address this concern, collision handling can be performed by the IBA in the same way as described earlier in the context of ESN collisions from TETs 110-T during registration.

Another potential concern relates to maintaining and cleaning up of reassembly buffers and/or terminal contexts in the IBA. Reassembly buffers are generally memory and data structures used to reassemble fragmented data packets as they are received by the IBA. For example, data packets are often broken into smaller fragments for transmission and need to be reassembled correctly upon arrival to ensure that the original data is accurately reconstructed. When a user terminal 110 receives fragmented packets, it stores these fragments in temporary memory areas called reassembly buffers. Maintaining these buffers involves tracking fragments, keeping track of which fragments have been received and which are still missing, storing the received fragments in the correct order, and handling timeouts by monitoring the time since the first fragment was received to ensure that reassembly is completed within a reasonable timeframe. If fragments are not received within this time, the process may be abandoned to free up resources.

Cleaning up reassembly buffers involves completing reassembly once all fragments of a data packet are received, processing it, and then clearing the buffer to free up memory for future packets. It also includes handling incomplete reassembly by discarding partial data and clearing the buffer if all fragments are not received within the expected time or if an error is detected, thus avoiding memory leaks and ensuring that the system can continue to function efficiently. Context management can involve removing any metadata or context information associated with the reassembly process to ensure that no residual data remains that could interfere with future reassembly processes. Effective maintenance and cleanup of reassembly buffers help to maintain system performance by handling incoming data efficiently without running out of memory or processing power, maintaining data integrity by preventing data corruption, and enhancing security by preventing potential vulnerabilities such as buffer overflow attacks where malicious data could exploit leftover data in the buffer.

In the described context, during registration, a user terminal 110 can go active and inactive multiple times. Each time the user terminal 110 becomes active, it may generate a new f-ESN, which is sent to the IBA via the context info. If the IBA were to employ the same policy in cleaning up unused contexts for both NTETs 110-N and TETs 110-T, the result can be an excessive number of reassembly buffer contexts being created for the f-ESN contexts within a noticeably brief period of time.

To address this concern, embodiments described herein provide a novel approach for IBA handling of cleanup when receiving a f-ESN. Embodiments of the IBA assign a temporary system-assigned identifier (T-SAI) when a user terminal 110 first sends the burst communication. As noted above, the burst communication indicates that it includes an f-ESN. In such cases, the IBA can track the f-ESN to the user terminal's 110 T-SAI, and the IBA is configured to clean up contexts created for f-ESNs immediately when the user terminal 110 goes inactive. For example, as soon as the IBA detects that it has not received any bursts for that context for a predetermined threshold period of time (e.g., a user hold time), the IBA immediately cleans up the context for that user terminal 110. This avoids having many contexts active at the same time, which would unnecessarily consume system resources.

Techniques described above and further herein support a secure end-to-end registration process for TETs 110-T. Such a process can be compatible with conventional registration of NTETs 110-N, such as in a hybrid network having both TETs 110-T and NTETs 110-N.

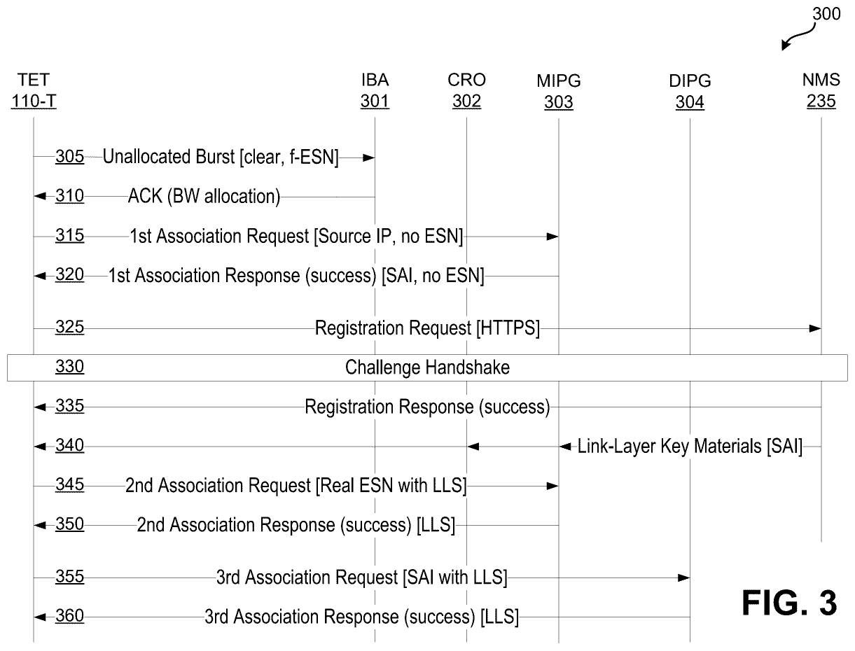

FIG. 3 shows a ladder diagram 300 for an illustrative secure terminal registration procedure, according to embodiments described herein. The ladder diagram 300 includes a TET 110-T, an IBA 301, and an NMS 235. Between the IBA 301 and the NMS 235, the ladder diagram 300 also shows a management Internet Protocol (IP) gateway (MIPG) 303 and a data IP gateway (DIPG) 304. All of the IBA 301, NMS 235, MIPG 303, and DIPG 304 are implemented in the ground station 120. In this context, the MIPG 303 and DIPG 304 are portions of an “IP gateway” (IPGW) that handle management traffic and user data traffic, respectively. The NMS 235 can function as a web server.

For added clarity, the ladder diagram 300 indicates signal communication stages 305-360. As described above, at stage 305, the TET 110-T sends an unallocated burst to the IBA 301. Because the TET 110-T has not yet been registered, the TET 110-T cannot secure its initial communications in a manner that would be understood end to end. Thus, the unallocated burst is sent in the clear (i.e., unencrypted, with terminal identifying information suppressed using the f-ESN). As described above, the unallocated burst includes a f-ESN and is configured to indicate that the ESN in fake in a manner that is understandable to the IBA 301 (e.g., using a designated bit, flag, etc.).

At stage 310, the IBA 301 responds to the unallocated burst by sending an acknowledgement message (ACK). The ACK is associated with the IBA 301 allocating bandwidth resources to the TET 110-T.

At stage 315, a first association procedure begins. The TET 110-T sends a first association request to the MIPG 303. There is still no link-layer security, and the first association request is sent without a real ESN. For example, the first association request identifies the TET 110-T by its source IP address (e.g., used for management traffic). As noted above, the MIPG 303 is a component of the ground station 120 that carries user terminals' 110 management traffic.

At stage 320, assuming a successful association, the MIPG 303 sends a first association response. The MIPG 303 advertises an IPv6 management router advertisement (RA) over the air. The IPv6 RA is a type of message used in the IPv6 protocol to facilitate network configuration and management. It is part of the neighbor discovery protocol (NDP), which helps with address autoconfiguration, discovery of other network nodes, determining the reachability of these nodes, etc. Advertising the RA provides the user terminal's 110 management plane source IP address prefix. For an NTET 110-N, the last four bytes of its real ESN are typically used as the last four bytes of its derived management IP address.

As noted above, because no link-layer key information has been generated or received at this stage, no link-layer security can be applied to the first association response. For example, even if registration is performed over HTTPS, the IP header is in clear (unencrypted) when messages are exchanged between a TET 110-T and the MIPG 303; and the TET's 110-T IP address (along with any ESN information) would similarly be in clear. This is incompatible with TRANSEC.

In embodiments described herein, at stage 315, the TET 110-T constructs its source IP address from an advertised IPv6 prefix by randomly generating a 4-byte number. This constructed source IP address is provided as part of the first association message to the MIPG 303. The MIPG 303 retrieves this 4-byte number from the TET's 110-T source IP address and sends this number as a temporary system-assigned terminal identity (T-SAI) towards the entity which generates the outroute link layer messages. On outroute, management packets are sent following generic stream encapsulation (GSE) with the T-SAI (the random 4-byte number) used as the GSE address. The TET 110-T accepts its packets, which have the GSE protocol data unit (PDU) address of the T-SAI, by matching the number it had used to derive its management plane source IP address.

Upon successful association with the network, the TET 110-T proceeds to register with the NMS 235. As stage 325, the TET 110-T sends a registration request to the NMS 235 using HTTPS. This request contains a unique (but still temporary) identifier for the TET 110-T (e.g., the T-SAI), configuration details, and any required authentication credentials. HTTPS ensures that the data transmitted is encrypted, which provides application layer security (e.g., using TLS, secure socket layer (SSL), etc.). Notably, use of HTTPS does not provide link-layer security.

At stage 330, responsive to the registration request at stage 325, the TET 110-T and the NMS 235 engage in a challenge handshake routine. This routine is a security mechanism designed to verify the authenticity of the TET 110-T and the network. The NMS 235 sends a challenge to the TET 110-T, typically a random string or nonce. The TET 110-T then responds with a cryptographic proof, such as a digital signature or hash, generated using its private key and the received challenge. This proof is sent back to the NMS 235 within a specified time frame. The NMS 235 verifies the response using the TET's 110-T public key, ensuring that the request is from a legitimate and trusted source.

At stage 335, upon successful verification of the challenge response, the NMS 235 sends a registration response back to the TET 110-T (again using HTTPS). This response includes confirmation of successful registration and can include additional configuration parameters. In connection with the registration response, link-layer key materials and a real SAI for the terminal are generated and sent from the NMS 235 to the TET 110-T at stage 340. Although shown as separate stages, stages 335 and 340 can be a single stage. Because there is still no link-layer security, the link-layer key materials and the real SAI can be sent using the T-SAI.

Once the TET 110-T completes its registration process and obtains its link layer key materials, it can now implement link-layer (end-to-end) security. The TET 110-T changes its management plane source IP address by appending its real ESN into the prefix. Subsequently, all management messages can be delivered with the TET's 110-T real ESN as the GSE address for terminal identification. As of this stage, all management messages are encrypted over the air including the terminal identity in the message using link-layer security (LLS) based on the link-layer key materials. The TET 110-T can now listen to the GSE address that is its real ESN.

At stage 345, following the completion of the initial registration process, the TET 110-T initiates a second association request with the MIPG 303 (indicating that TET 110-T is a TE terminal). This time, the request includes the real ESN sent using LLS. As noted above, the LLS ensures that communication of the ESN is encrypted at the link layer, providing end-to-end security. This second association request seeks to establish a secure and authenticated link between the TET 110-T and the management infrastructure (e.g., the MIPG 303), ensuring that all subsequent communications are protected against eavesdropping and tampering.

At stage 350, the system responds to the second association request with a second association response. This response confirms the successful establishment of a secure association using the real ESN and LLS. The acknowledgment from the system indicates that the link-layer security is now active, and the TET 110-T can securely communicate with the network management system. The response may also include additional configuration parameters and security keys that further enhance the security and integrity of the communication.

At stage 355, the TET 110-T can initiate a third association request, this time with the DIPG 304. This request sends the real SAI (i.e., assigned by the system after registration) using LLS. At stage 360, the DIPG 304 responds to the third association request with a third association response. As described above, the SAI was generated as an identifier that can be used for routing and managing traffic within the network, including data traffic. The third association exchange can ensure secure communication of user data traffic.

Notably, the process described in FIG. 3 is compatible with conventional association and registration for NTETs 110-N, such as in hybrid networks having both NTETs 110-N and TETs 110-T. In particular, the process described in FIG. 3 can be implemented to implement TRANSEC for TETs 110-T without adding any overhead to NTET 110-N communications. For example, for an NTET 110-N, the unallocated burst is sent in stage 305 with the real ESN for the NTET 110-N. Accordingly, the bandwidth allocation in stage 310 is associated with the real context information for the requesting NTET 110-N. Similarly, the association and registration routines of stages 315-340 can be performed for the NTET 110-N in a similar manner as for the TET 110-T, except that the routines use the real ESN from the start. As such, for an NTET 110-N, there is no need to perform re-association stages 345-360.

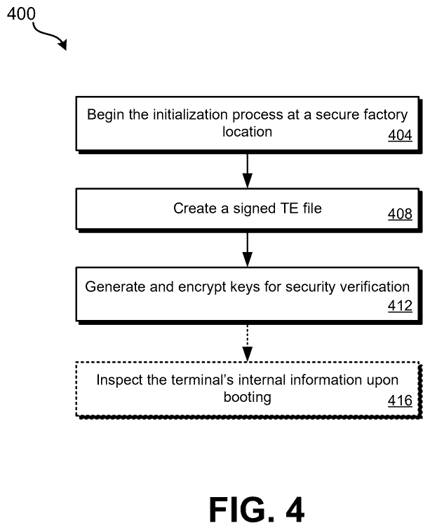

FIG. 4 shows a flow diagram of an illustrative method 400 for initial configuration of a TRANSEC-enabled terminal (TET), according to embodiments described herein. The method 400 begins at stage 404 by initializing the TET at a secure factory location. A user terminal 110 is designated as a TRANSEC-enabled terminal (TET 110-T) by a trusted agent (TA). The TA includes a group of secret information in the terminal's factory image, which identifies the terminal as a TET 110-T. This secret information is only accessible by the terminal's software. Additionally, each TET 110-T is uniquely associated with a Terminal Master Key (TMK) and an Electronic Serial Number (ESN) of its internal circuitry, such as an application-specific integrated circuit (ASIC). The TA burns the TMK and the ESN into a secure memory location that only the specific TET 110-T can access.

At stage 408, embodiments can create a signed TE file. If the user terminal 110 is determined to be a TET 110-T, a signed TE file is generated and incorporated into the terminal's factory image. This file is not visible in the flash file system and is secret to others. The signed TE file may be burned into the factory image as part of establishing the terminal's in-system programmable device identifier (ISPDID). This identifier includes essential firmware, software drivers, initial settings, and security features, ensuring that only the TET 110-T can read and interpret the signed TE file.

At stage 412, embodiments can generate and encrypt keys for security verification. A well-known string is signed by generating a 256-bit key called the signature master key (SMK). The SMK is then encrypted by the TMK to produce the encrypted signature master key (ESMK). A well-known clear string (KS) is encrypted by the SMK, resulting in the encrypted well-known string (EKS). These encrypted keys are stored in the factory image, ensuring that the terminal can verify its own security credentials upon booting.

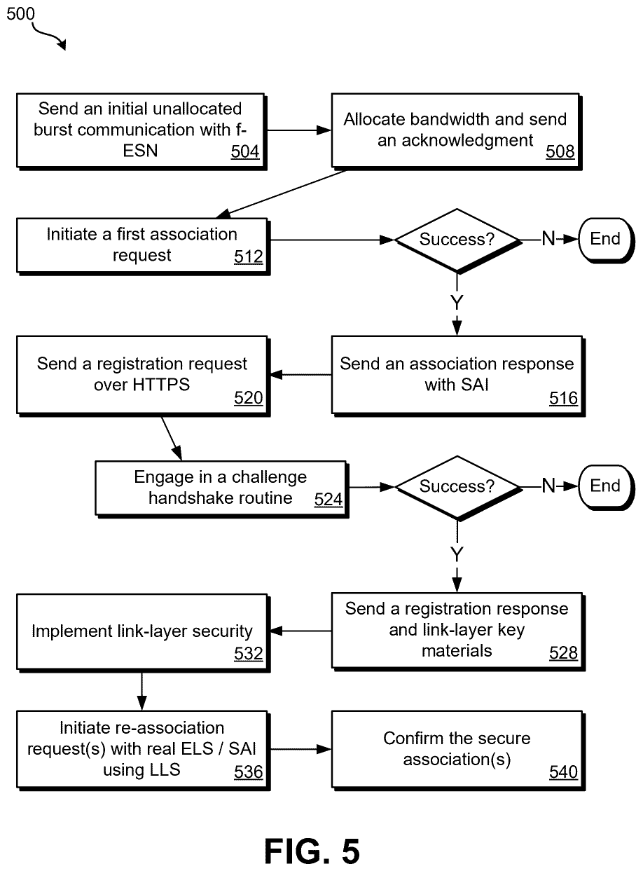

In some embodiments, at stage 416, embodiments can inspect the terminal's internal information upon booting. Every time the user terminal 110 boots up, it checks for the presence of the signed TE file. If the file is not found, the terminal operates as a non-TRANSEC-enabled terminal (NTET 110-N). If the file is present, the terminal decrypts the ESMK using the TMK to retrieve the SMK, and then decrypts the EKS using the SMK to obtain the KS. If successful, the terminal identifies itself as a TET 110-T and prepares for secure communication (e.g., according to the method 500 of FIG. 5).

FIG. 5 shows a flow diagram of an illustrative method 500 for initializing a TRANSEC-enabled terminal (TET) for secure communications in a satellite communication network, according to embodiments described herein. The method 500 begins at stage 504 by sending an initial unallocated burst communication to a ground terminal 120 via a satellite 105 (e.g., based on the ALOHA protocol, or the like). For example, the TET 110-T sends an unallocated burst communication to an inroute bandwidth allocator (IBA) to obtain stream bandwidth. This burst includes a fake ESN (f-ESN) to temporarily identify the terminal until it obtains its link-layer keys. The burst is configured to indicate that the ESN is fake, which the IBA recognizes and processes accordingly.

At stage 508, embodiments can allocate bandwidth and send an acknowledgment. The ground terminal 120 (e.g., IBA) responds to the unallocated burst by allocating bandwidth resources and sending an acknowledgment message (ACK) to the TET 110-T. This allocation allows the terminal to proceed with the registration process.

At stage 512, embodiments can initiate a first association request. The TET 110-T sends a first association request to the ground terminal 120 (e.g., to a management Internet Protocol gateway (MIPG) 303). This request is sent without link-layer security and uses a randomly generated 4-byte number as part of its source IP address. The MIPG 303 retrieves this number and sends it as a temporary system-assigned terminal identity (T-SAI) towards the entity that generates the outroute link layer messages.

At stage 516, embodiments can send a first association response. As illustrated, there can be a determination of whether the first association request in stage 512 is successful. If not, the method 500 can end; if so, (i.e., upon successful association), the ground terminal 120 (e.g., MIPG 303) sends the first association response at stage 516. For example, the first association response includes an over-the-air IPv6 management router advertisement (RA). This RA provides the user terminal's management plane source IP address prefix, enabling the terminal to construct its source IP address from the advertised prefix. The TET 110-T can determine the T-SAI (explicitly or implicitly) from the first association response.

At stage 520, embodiments can send a registration request over HTTPS. The TET 110-T sends a registration request to the ground terminal 120 (e.g., to the NMS 235) using HTTPS. The request can include the T-SAI, configuration details, and any required authentication credentials. HTTPS ensures that the transmitted data is encrypted, providing application layer security (but not link-layer security).

At stage 524, embodiments can engage in a challenge handshake routine. In response to the registration request, the ground terminal 120 (e.g., the NMS 235) sends a challenge to the TET 110-T. For example, the TET 110-T responds with a cryptographic proof generated using its private key and the received challenge. The NMS 235 verifies this response using the terminal's public key to ensure the request is legitimate.

At stage 528, embodiments can send a registration response and link-layer key materials. As illustrated, there can be a determination of whether the handshake routine in stage 524 is successful. If not, the method 500 can end; if so (i.e., upon successful verification), the ground terminal 120 (e.g., NMS 235) sends a registration response and link-layer key materials to the TET 110-T. These materials include a real SAI and encrypted traffic session keys.

At stage 532, embodiments can implement link-layer security. The TET 110-T changes its management plane source IP address by appending its real ESN into the prefix. All subsequent management messages are encrypted over the air using link-layer security (LLS) based on the link-layer key materials. The terminal can now securely communicate with the network.

At stage 536, embodiments can initiate one or more re-association requests using LLS. The TET 110-T sends each additional association request to the ground terminal 120 including the real ESN and using LLS. At stage 540, embodiments (e.g., the ground terminal 120) can confirm the secure association. The ground terminal 120 responds with one or more re-association response(s) responsive to the one or more re-association requests, each confirming the successful establishment of a secure association using the real ESN and LLS. Each response may include additional configuration parameters and security keys. The re-association request(s) and response(s) establish a secure and authenticated link between the terminal and the network.

In some implementations, the re-association request(s) and response(s) of stages 536 and 540 include a second association request sent from the TET 110-T to the MIPG 303 and a second association response received by the TET 110-T from the MIPG 303. The request and response use the real ESN and using LLS. This second association request and response establishes a secure and authenticated link between the terminal and the management infrastructure. In some implementations, the re-association request(s) and response(s) of stages 536 and 540 include a third association request sent from the TET 110-T to the DIPG 304 and a third association response received by the TET 110-T from the DIPG 304. In some implementations, the request and response use the SAI and LLS. This request and response ensure secure communication of user data traffic within the network.

As noted above, after LLS is established, embodiments use the real ESN of the TET 110-T for management-related communications and a real SAI for user-data-related communications. The ESN is a unique identifier that is permanently assigned to each terminal. Using the ESN helps to ensure that the management infrastructure can uniquely and consistently identify the TET 110-T across all management-related operations. For example, communication of configuration and control commands can rely on a stable and unique identifier. Conversely, the SAI is useful as an identifier for routing and managing user data traffic within the network without permanently binding to the TET's 110-T unique ESN. Using the SAI allows the network to efficiently handle and route data traffic, as it provides a flexible and context-specific identifier. This flexibility also supports dynamic network environments in which terminals may frequently join and leave the network. Further, use of the SAI for user-data-related communications can help to reduce the overhead associated with using the ESN.

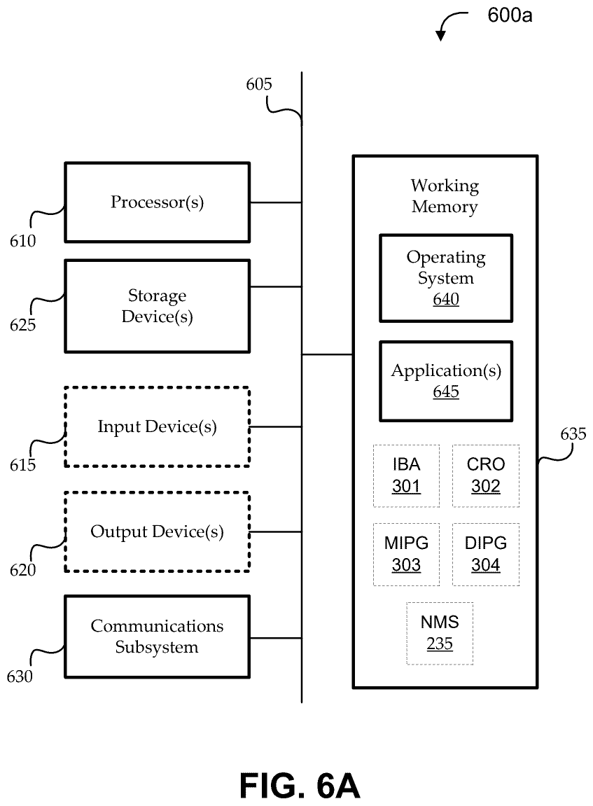

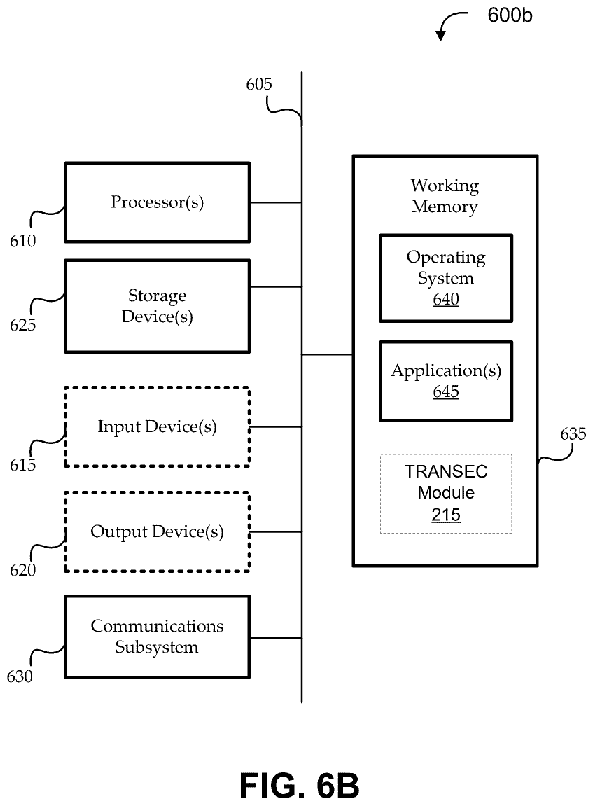

In some embodiments, components of the TET 110-T and/or the ground station 120 are implemented by a computational system. FIGS. 6A and 6B provide schematic illustrations of embodiments of computational systems 600 that can implement various system components and/or perform various steps of methods provided by various embodiments. The computational system 600a of FIG. 6A can be an implementation of a TE ground station 120, and the computational system 600b of FIG. 6B can be an implementation of a TET 110-T. FIGS. 6A and 6B are meant only to provide a generalized illustration of various components, any or all of which may be utilized as appropriate. FIGS. 6A and 6B, therefore, broadly illustrates how individual system elements may be implemented in a relatively separated or relatively more integrated manner.

The computational system 600 is shown including hardware elements that can be electrically coupled via a bus 605 (or may otherwise be in communication, as appropriate). The hardware elements may include one or more processors 610, including, without limitation, one or more general-purpose processors and/or one or more special-purpose processors (such as digital signal processing chips, graphics acceleration processors, video decoders, and/or the like). Optionally, embodiments of the computational system 600 can include one or more input devices 615, and/or one or more output devices 620. The input devices 615 can include user input devices (e.g., a mouse, a keyboard, remote control, touchscreen interfaces, audio interfaces, video interfaces, and/or the like) and/or machine input devices (e.g., computer-to-computer interfaces, such as wired and/or wireless input data ports). Similarly, the output devices 620 can include user output devices (e.g., display devices, printers, and/or the like), and/or machine input devices (e.g., computer-to-computer interfaces, such as wired and/or wireless output data ports).

The computational system 600 may further include (and/or be in communication with) one or more non-transitory storage devices 625, which can comprise, without limitation, local and/or network accessible storage, and/or can include, without limitation, a disk drive, a drive array, an optical storage device, a solid-state storage device, such as a random-access memory (“RAM”), and/or a read-only memory (“ROM”), which can be programmable, flash-updateable and/or the like. Such storage devices may be configured to implement any appropriate data stores, including, without limitation, various file systems, database structures, and/or the like. In some embodiments, the storage devices 625 include memory for storing encryption keys, encrypted data, and/or other information used by embodiments to implement features described herein.

The computational system 600 can also include a communications subsystem 630, which can include, without limitation, a modem, a network card (wireless or wired), an infrared communication device, a wireless communication device, and/or a chipset (such as a Bluetooth™ device, an 802.11 device, a WiFi device, a WiMax device, cellular communication device, etc.), and/or the like. Depending on where in the network the computational system 600 is deployed, the communications subsystem 630 can include any suitable hardware and/or software components for communicating with other salient portions of the network.

In some implementations of computational system 600a, the communications subsystem 630 includes components for interfacing with a satellite network (e.g., antenna system 220-G, modem/router 210-G) and/or for interfacing with terrestrial backhaul networks and/or other networks. In some implementations of computational system 600b, the communications subsystem 630 includes components for interfacing with a satellite network and/or for interfacing with local networks, user networks, and/or other networks. For example, computational system 600b can include some or all of antenna system 220-T and/or modem/router 210-T.

The computational system 600 further includes a working memory 635, which can include a RAM or ROM device, as described herein. The computational system 600 also can include software elements, shown as currently being located within the working memory 635, including an operating system 640, device drivers, executable libraries, and/or other code, such as one or more application programs 645, which may include computer programs provided by various embodiments, and/or may be designed to implement methods, and/or configure systems, provided by other embodiments, as described herein. Merely by way of example, one or more procedures described with respect to the method(s) discussed herein can be implemented as code and/or instructions executable by a computer (and/or a processor within a computer); in an aspect, then, such code and/or instructions can be used to configure and/or adapt a general-purpose computer (or other device) to perform one or more operations in accordance with the described methods. As illustrated, the operating system 640 and the working memory 635 can be used in conjunction with the one or more processors 610 to implement the some or all of the initialization and secure registration processes for TRANSEC-enabled terminals.

For example, in implementations of computational system 600a, the working memory 635 can be used in conjunction with the one or more processors 610 to implement the some or all of the IBA 301, CRO 302, MIPG 303, DIPG 304, NMS 235, etc. In implementations of computational system 600b, the working memory 635 can be used in conjunction with the one or more processors 610 to implement the some or all of the TRANSEC module 215.

A set of these instructions and/or codes can be stored on a non-transitory (or non-transient) computer-readable storage medium, such as the non-transitory storage device(s) 625 described above. In some cases, the storage medium can be incorporated within a computer system, such as computational system 600. In other embodiments, the storage medium can be separate from a computer system (e.g., a removable medium, such as a compact disc), and/or provided in an installation package, such that the storage medium can be used to program, configure, and/or adapt a general-purpose computer with the instructions/code stored thereon. These instructions can take the form of executable code, which is executable by the computational system 600 and/or can take the form of source and/or installable code, which, upon compilation and/or installation on the computational system 600 (e.g., using any of a variety of generally available compilers, installation programs, compression/decompression utilities, etc.), then takes the form of executable code.

In some embodiments, the computational system 600 implements a portion of a system for communicating a data signal in a wireless communication network, as described herein. In some embodiments, the non-transitory storage device(s) 625 can have instructions stored thereon, which, when executed, cause the processor(s) 610 to perform steps of the method 500 of FIG. 5.

It will be apparent to those skilled in the art that substantial variations may be made in accordance with specific requirements. For example, customized hardware can also be used, and/or particular elements can be implemented in hardware, software (including portable software, such as applets, etc.), or both. Further, connection to other computing devices, such as network input/output devices, may be employed.

As mentioned above, in one aspect, some embodiments may employ a computer system (such as the computational system 600) to perform methods in accordance with various embodiments of the invention. According to a set of embodiments, some or all of the procedures of such methods are performed by the computational system 600 in response to processor 610 executing one or more sequences of one or more instructions (which can be incorporated into the operating system 640 and/or other code, such as an application program 645) contained in the working memory 635. Such instructions may be read into the working memory 635 from another computer-readable medium, such as one or more of the non-transitory storage device(s) 625. Merely by way of example, execution of the sequences of instructions contained in the working memory 635 can cause the processor(s) 610 to perform one or more procedures of the methods described herein.

The terms “machine-readable medium,” “computer-readable storage medium” and “computer-readable medium,” as used herein, refer to any medium that participates in providing data that causes a machine to operate in a specific fashion. These mediums may be non-transitory. In an embodiment implemented using the computational system 600, various computer-readable media can be involved in providing instructions/code to processor(s) 610 for execution and/or can be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the non-transitory storage device(s) 625. Volatile media include, without limitation, dynamic memory, such as the working memory 635. Common forms of physical and/or tangible computer-readable media include, for example, a floppy disk, a flexible disk, hard disk, magnetic tape, or any other magnetic medium, a CD-ROM, any other optical medium, any other physical medium with patterns of marks, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 610 for execution. Merely by way of example, the instructions may initially be carried on a disk of a remote computer. The remote computer can load the instructions into its dynamic memory and send the instructions as signals over a transmission medium to be received and/or executed by the computational system 600. The communications subsystem 630 (and/or components thereof) generally will receive signals, and the bus 605 then can carry the signals (and/or the data, instructions, etc., carried by the signals) to the working memory 635, from which the processor(s) 610 retrieves and executes the instructions. The instructions received by the working memory 635 may optionally be stored on a non-transitory storage device 625 either before or after execution by the processor(s) 610.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A method for initializing a transmission security (TRANSEC) enabled (TE) terminal for secure communication in a satellite communication network, the method comprising:
receiving, by a ground station of the satellite communication network from a TE user terminal (TET), an unallocated burst transmission that includes an electronic serial number (ESN) of the user terminal and indicates that the ESN is a fake ESN (f-ESN), the TET previously assigned a real ESN, the f-ESN being different from the real ESN;
allocating bandwidth resources of the satellite communication network to the TET by the ground station based on the f-ESN;
receiving an association request by the ground station from the TET;
sending an association response, by the ground station to the TET, the association response including a temporary system-assigned identifier (T-SAI) generated for the TET;
receiving a registration request by the ground station from the TET; and
sending a registration response, by the ground station to the TET, the registration response including link-layer encryption keys and a real system-assigned identifier (SAI) generated for the TET.

2. The method of claim 1, further comprising:
receiving a re-association request by the ground station from the TET, the re-association request sent with link-layer encryption based on the link-layer encryption keys; and
sending a re-association response, by the ground station to the TET, the re-association response confirming a secure association between the TET and the satellite communication network supporting end-to-end link-layer-secure communications.

3. The method of claim 2, wherein the re-association request includes the real ESN of the TET encrypted with the link-layer encryption.

4. The method of claim 2, wherein:
receiving the re-association request comprises:
receiving a first re-association request by a management gateway of the ground station, the first re-association request including the real ESN of the TET encrypted with the link-layer encryption; and
receiving a second re-association request by a data gateway of the ground station, the second re-association request including the SAI of the TET encrypted with the link-layer encryption; and
the second re-association response comprises:
sending a first re-association response by the management gateway to confirm secure association for management traffic; and
sending a second re-association response by the data gateway to confirm secure association for user data traffic.

5. The method of claim 1, wherein the association request includes a constructed source address generated by the TET partially based on a random number.

6. The method of claim 5, wherein the T-SAI is generated by the ground station partially based on the random number.

7. The method of claim 1, further comprising:
determining, responsive to receiving the association request, whether there is successful association of the TET with the satellite communication network,
wherein the sending the association response is performed only upon determination that there is successful association of the TET.

8. The method of claim 1, further comprising:
engaging in a challenge handshake routine between the ground station and the TET responsive to receiving the registration request,
wherein the sending the registration response is performed only upon successful completion of the challenge handshake.

9. The method of claim 1, wherein the association response comprises an over-the-air Internet protocol (IP) management router advertisement.

10. The method of claim 1, wherein the registration request and the registration response are both communicated using secure hypertext transfer protocol (HTTPS).

11. The method of claim 1, wherein the unallocated burst transmission is set by the TET only upon successful validation, by the TET during a bootup routine, of internal security credentials in a signed TE file stored in a factory image of the TET.

12. The method of claim 11, wherein the successful validation is performed by:
checking presence of the signed TE file; and
responsive to verifying presence of the signed TE file:
decrypting an encrypted signature master key (ESMK) using a terminal master key (TMK) to retrieve a decrypted signature master key (dSMK); and
decrypting an encrypted clear string (EKS) using the dSMK to retrieve a decrypted clear string (dKS); and
validating the signed TE file based on determining that the dKS matches a well-known clear string (KS),
wherein, during factory configuration of the TET, the TMK and the real ESN were stored in a secure memory location of the TET, a well-known key was signed to generate a signature master key (SMK), the SMK was encrypted using the TMK to produce the ESMK, and the KS was encrypted using the SMK to generate the EKS.

13. The method of claim 1, wherein the satellite communication network comprises a plurality of user terminals including at least the TET and a non-TE user terminal (NTET), wherein each of the plurality of user terminals is previously and uniquely assigned a respective real ESN.

14. A transmission security (TRANSEC) enabled (TE) ground station for initializing a TE terminal (TET) for secure communication in a satellite communication network, the ground station comprising:
an inroute bandwidth allocator (IBA) configured to:
receive, from the TET, an unallocated burst transmission that includes an electronic serial number (ESN) of the TET and indicates that the ESN is a fake ESN (f-ESN), the TET previously assigned a real ESN, the f-ESN being different from the real ESN; and
allocate bandwidth resources of the satellite communication network to the TET by the ground station based on the f-ESN;
a management gateway configured, in response to receiving an association request from the TET, to send an association response to the TET, the association response including a temporary system-assigned identifier (T-SAI) generated for the TET; and
a network management system (NMS) configured, in response to receiving a registration request from the TET, to send a registration response to the TET, the registration response including link-layer encryption keys and a real system-assigned identifier (SAI) generated for the TET.

15. The ground station of claim 14, wherein the management gateway is further configured to:
receive a re-association request from the TET, the re-association request including the real ESN of the TET encrypted with the link-layer encryption; and
send a re-association response to the TET, the re-association response confirming a secure association between the TET and the satellite communication network supporting end-to-end link-layer-secure communications for management traffic.

16. The ground station of claim 14, further comprising:
a data gateway configured to:
receive a re-association request from the TET, the re-association request including the SAI encrypted with the link-layer encryption; and
send a re-association response to the TET, the re-association response confirming a secure association between the TET and the satellite communication network supporting end-to-end link-layer-secure communications for user data traffic.

17. The ground station of claim 14, wherein:
the association request includes a constructed source address generated by the TET partially based on a random number; and the T-SAI is generated partially based on the random number.

18. The ground station of claim 14, wherein the ground station is in communication with a plurality of user terminals comprising one or more TETs and one or more non-TE user terminal (NTET), wherein each of the plurality of user terminals is previously and uniquely assigned a respective real ESN.

19. A system for initializing a transmission security (TRANSEC) enabled (TE) terminal for secure communication in a satellite communication network, the system comprising:
one or more processors;
a non-transitory computer-readable storage medium having instructions stored thereon which, when executed, cause the one or more processors to performs steps comprising:
receiving, from a TE user terminal (TET), an unallocated burst transmission that includes an electronic serial number (ESN) of the user terminal and indicates that the ESN is a fake ESN (f-ESN), the TET previously assigned a real ESN, the f-ESN being different from the real ESN;
allocating bandwidth resources of the satellite communication network to the TET based on the f-ESN;
receiving an association request from the TET;
sending an association response to the TET, the association response including a temporary system-assigned identifier (T-SAI) generated for the TET;
receiving a registration request from the TET; and
sending a registration response to the TET, the registration response including link-layer encryption keys generated for the TET.

20. The system of claim 19, wherein the instructions further comprise:
receiving a re-association request from the TET, the re-association request sent with link-layer encryption based on the link-layer encryption keys; and
sending a re-association response to the TET, the re-association response confirming a secure association between the TET and the satellite communication network supporting end-to-end link-layer-secure communications.
